(19) United States
(12) Patent Application Publication
(10) Pub. No.: US 2015/0253178 A1
(43) Pub. Date: Sep. 10, 2015

(54) Container Monitoring Apparatus

(71) Applicant: OneSubsea IP UK Limited, London (GB)

(72) Inventors: Patrice Ligneul, Chaville (FR); Jason Milne, Orsay (FR); Lenny Sutherland, Aberdeenshire (GB)

(73) Assignee: OneSubsea IP UK Limited, London (GB)

(21) Appl. No.: 14/643,953

(22) Filed: Mar. 10, 2015

Related U.S. Application Data
(60) Provisional application No. 61/950,713, filed on Mar. 10, 2014.

(51) Int. Cl. G01F 23/296; B63B 51/00; B63B 22/28

(52) U.S. Cl. CPC G01F 23/296; B63B 22/28; B63B 51/00; B63B 2201/00; B63B 2201/14

(57) ABSTRACT

An apparatus to acoustically monitor a container includes a first acoustic transducer mountable to an exterior of the container to send a first acoustic signal into an interior of the container and a second acoustic transducer mountable to the exterior of the container to send a second acoustic signal into the interior of the container. The apparatus further includes a data processing unit to process a first acoustic response signal related to the first acoustic signal and a second acoustic response signal related to the second acoustic signal to determine contents within the interior of the container at locations of the first acoustic transducer and the second acoustic transducer.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood that these statements are to be read in this light, and not as admissions of prior art.

Subsea oil and gas field architecture integrates a pipeline network to transport the production fluid from the wellhead to the surface facilities. As part of this pipeline network a riser pipe structure is provided close to the surface process facilities to lift the fluid from the seabed to the surface.

In some applications, the riser structure may contain a buoyancy tank providing an uplift tension to one or more of the conduit(s) and flexible pipe connecting the top of the riser to surface process facilities. Accidental flooding of the buoyancy tank could create a potential hazard to the riser structure and expose the field to a risk of catastrophic failure if a sufficient uplift tension is not applied to the vertical riser pipe system. The tensioning ensures that a marine structure does not experience excursions from an upright position that would fall outside acceptable limits, even during extreme weather conditions.

To mitigate the risk of failure, instrumentation may be installed to monitor possible accidental flooding of the buoyancy tanks. Tension can be monitored to ensure stability, taking into account the weight of the structure and the weight of the pipelines/risers hanging off the structure. Known tension measurement techniques, however, may have some inherent drift. A sudden ingression of a larger amount of water can be adequately detected as a transient change in the tension measurement above the time drift slope. However, inherent drift limits the ability of conventional measurement techniques to distinguish slow-rate of water ingression into a buoyancy tank from tension measurement drift. Accordingly, detection of levels of fluids and changes to the fluid flow within a tank remains a priority, such as to more accurately determine buoyancy of a buoyancy tank.

### BRIEF DESCRIPTION OF THE DRAWINGS

Various embodiments of the disclosed tubing hanger with shuttle rod valve will become better understood when the following detailed description is read with reference to the accompanying figures, in which like characters represent like parts throughout.

FIG. 1 shows subsea oil and gas field architecture in accordance with one or more embodiments of the present disclosure;

FIGS. 2A and 2B show an apparatus in use with a buoyancy tank in accordance with one or more embodiments of the present disclosure;

FIG. 3 shows a diagram of acoustic pulses transmitted and reflected with respect to a container wall in accordance with one or more embodiments of the present disclosure;

FIG. 4 shows a schematic cross-sectional view of an apparatus to acoustically monitor a container in accordance with one or more embodiments of the present disclosure;

FIGS. 5A-5C show multiple schematic views of an acoustic transducer in accordance with the present disclosure;

FIG. 6 shows multiple views of an alarm shuttle of an apparatus in accordance with one or more embodiments of the present disclosure; and

FIG. 7 shows a diagram and representation of an apparatus used to monitor an internal water level of a container.

### DETAILED DESCRIPTION OF SPECIFIC EMBODIMENTS

The following discussion is directed to various embodiments of the present disclosure. The drawing figures are not necessarily to scale. Certain features of the embodiments may be shown exaggerated in scale or in somewhat schematic form and some details of conventional elements may not be shown in the interest of clarity and conciseness. The embodiments disclosed should not be interpreted, or otherwise used, as limiting the scope of the disclosure, including the claims. It is to be fully recognized that the different teachings of the embodiments discussed below may be employed separately or in any suitable combination to produce desired results. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but are the same structure or function, unless explicitly stated.

In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. In addition, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. The use of “top,” “bottom,” “above,” “below,” and variations of these terms is made for convenience, but does not require any particular orientation of the components.

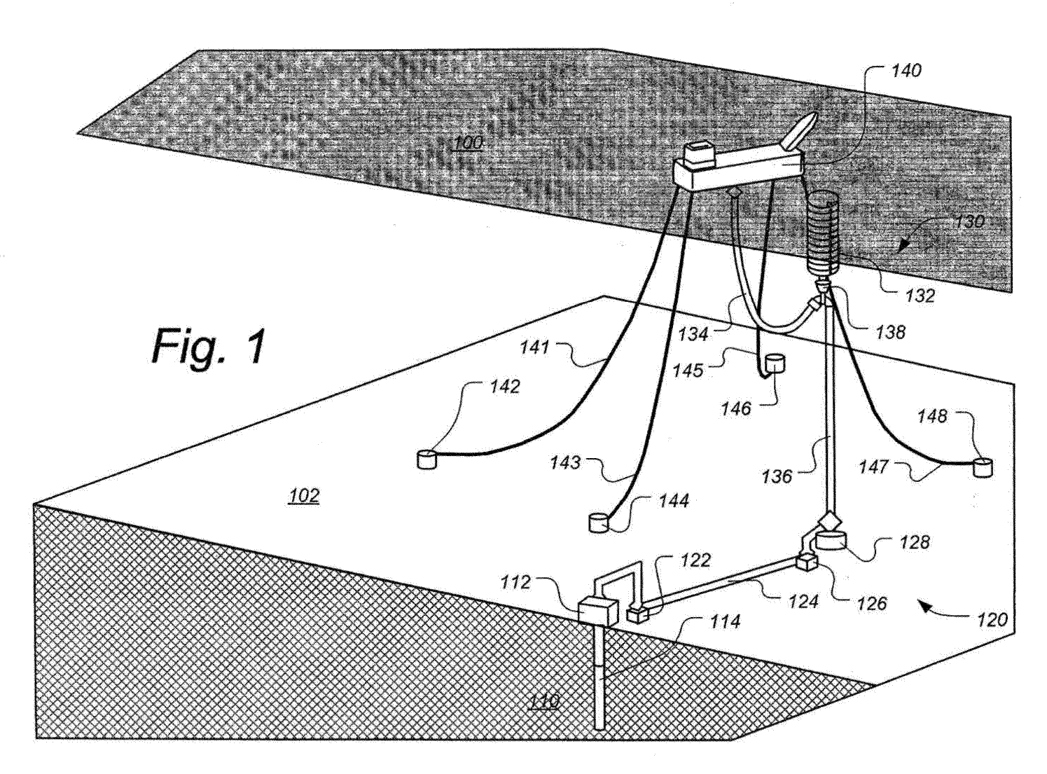

FIG. 1 shows subsea oil and gas field architecture in accordance with one or more embodiments of the present disclosure. The subsea oil and gas field architecture shown includes a pipeline network 120 to transport production fluid from the wellhead 112 on the seafloor 102 to the surface facilities on the sea surface 100. The wellhead 112 draws production fluid from subterranean rock formation 110 using wellbore 114. In the example shown in FIG. 1, the production fluid flows along a sea floor flowline 124 that terminates at a pipe termination 122 one end and at a spool piece 126 on the other end. As part of pipeline network 120, a riser pipe structure 130 is provided close to the surface process facilities to lift the fluid from the seabed 102 to the surface 100. In some examples of this network 120, for deep and ultra-deep water, operators have adopted a hybrid free standing riser architecture that may include one or more of the following: a seabed riser anchor base 128; a vertical single or bundled riser pipe(s) 136 anchored to the seabed anchor base 128; a buoyancy tank 132 providing an uplift tension to vertical riser pipe(s) 136; a flexible pipe 134 connecting the top of the vertical riser 136 to the surface process facilities (FPSO) 140; and a flexible joint 138 for connecting the buoyancy tank 132 to the vertical riser 136. The FPSO 140 may be anchored to the seafloor 102 using mooring lines 141, 143, 145, and 147 along with suction anchors 142, 144, 146, and 148, respectively.

Any loss of buoyancy and flooding of the buoyancy tank 132 could create a potential hazard to the riser system 130 and expose the field to a risk of catastrophic failure if a sufficient uplift tension is not applied to the vertical pipe system 136. In accordance with one or more embodiments, to mitigate this risk, the buoyancy tank 132 may be monitored to determine if flooding is occurring within the buoyancy tank 132. The buoyancy tank 132 may also be divided into a vertical stack of several independent compartments, as shown, such as to limit the amount of water that could accidentally fill the buoyancy tank 132.

When the buoyancy tank 132 is immersed below the surface 100 at depth greater than the conventional depth of human intervention (e.g., greater than 100 meters), a remotely operated vehicle (ROV) may interact with the buoyancy tank 132 and the other submerged components of the pipeline network 120 and the riser pipe structure 130.

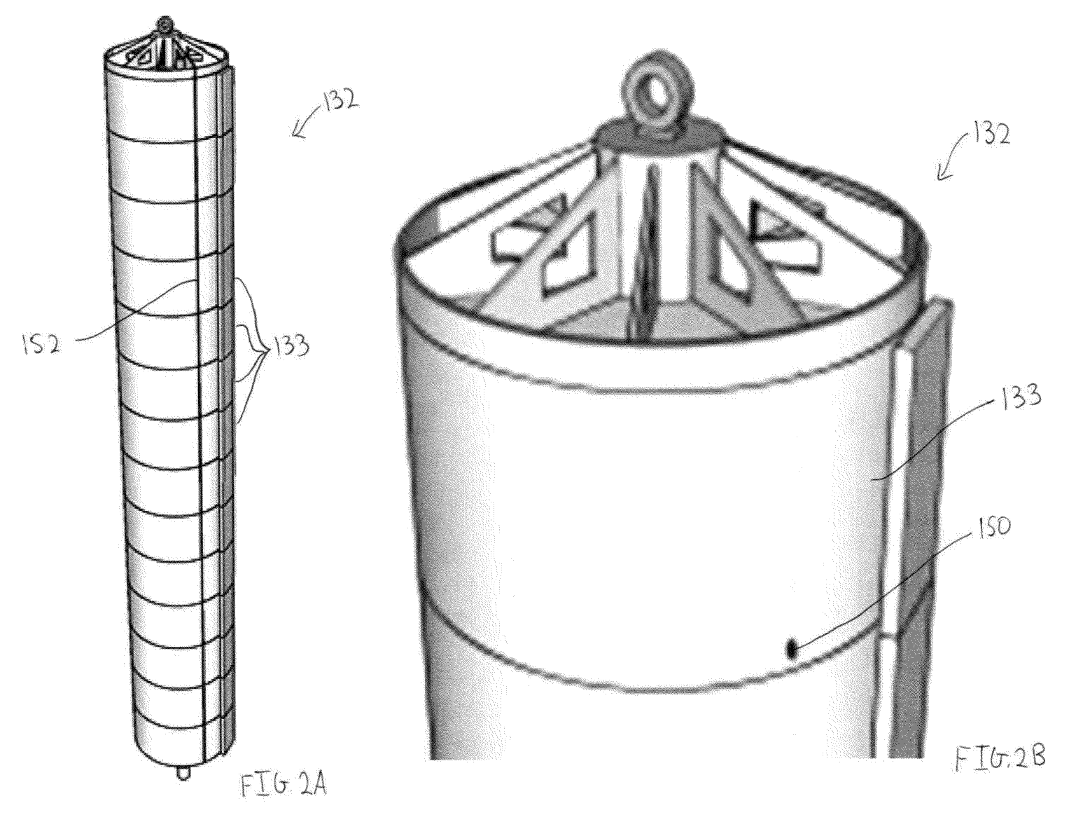

FIGS. 2A and 2B show a buoyancy tank 132 in accordance with one or more embodiments of the present disclosure. As discussed above, the buoyancy tank 132 may include multiple compartments 133 that may be coupled together and stacked upon each other. Further, an apparatus 150 may be used to monitor the contents of the buoyancy tank 132, or in this case a compartment 133 of the buoyancy tank 132. The apparatus 150 may be used to determine the contents of the buoyancy tank 132, such as if water or air is included within the buoyancy tank 132, and if flooding is occurring into the buoyancy tank 132. In this embodiment, an apparatus 150 may be coupled to each compartment 133 of the buoyancy tank 132. As the monitoring apparatus 150 may be used to determine the contents of the compartment 133 at the location of the apparatus 150, the monitoring apparatus 150 may be coupled near or adjacent the bottom of the compartment 133 where flooding would begin first within the compartment 133. Further, in one or more embodiments including multiple monitoring apparatuses 150, the monitoring apparatuses 150 may be in communication with each other. For example, as shown in FIG. 2A, a cable 152 may extend between the monitoring apparatuses 150. The cable 152 may also be used so that the monitoring apparatuses 150 may be in communication with surface equipment or a surface vessel. Further, in one or more embodiments, the monitoring apparatuses 150 may alternatively be in communication with each other wirelessly, and/or may communicate with surface equipment or a surface vessel wirelessly.

The monitoring apparatus 150 may include one or more acoustic sensors (e.g., one or more acoustic transducers) and may be coupled to the exterior of the buoyancy tank 132, such as through the use of magnets. The acoustic transducer may be used to acoustically excite the buoyancy tank 132 and then listen to the acoustic response, allowing detection of the presence and/or level of water within the interior of the tank 132.

In one or more embodiments, the detection is achieved by analyzing the response to an acoustic signal, in which the response will exhibit different characteristics depending on the medium on the opposite face of the buoyancy tank wall. As the buoyancy tank may be made from metal (e.g., steel), the difference arises in part from the difference in the acoustic reflection coefficient of a steel-water and steel-air interface. According to some embodiments, a vertical array of acoustic transducers allows the water level to be determined by analyzing which transducers are adjacent to water, which are adjacent to air, and which are adjacent to a water/air interface. When the buoyancy tank 132 is segmented into individual compartments 133, at least one monitoring apparatus 150 including two or more acoustic transducers may be used for each compartment 133.

The monitoring of the individual compartments 133 of the buoyancy tank 132 enables more precise information regarding the nature of any ingression that would otherwise be possible with a conventional tension measurement system. For example, a conventional tension measurement cannot differentiate between 1 ton of water ingression into a single compartment and 0.2 tons of water ingression into five compartments. The particular compartment(s) where the ingression is occurring can also be identified immediately, without additional diagnostic equipment. An apparatus or a system in accordance with one or more embodiments provides a sensor that may be capable of water level detection and/or the rate of the water ingress over a given period of time.

### Principles of the Measurement

Buoyancy tanks are generally made of several compartments, each with characteristic dimensions of height h, diameter d and wall thickness e. Typical dimensions for h, d, and e are 3 m, 6 m, and 15 mm, respectively.

Buoyancy tank sections are initially filled with either gas and/or water: normal operations of installation and long-term operation may require ballasting or de-ballasting of the system, and leaks due to corrosion or external damage may result in a gradual (or brutal) ingression of water into the tank. As the tank has very slow motion, any invaded water will sit at the bottom of a compartment, with a free surface at the height f from the bottom tank filled out with sea water leaving a layer of air at the height h-f. A measurement of the water level can therefore be performed by measuring the water level with an acoustic transducer placed near the bottom of each tank. Water ingression will appear as a gradual change in the acoustic response measured by the transducer.

### Acoustic Behavior

The acoustic impedance Z is defined as the product of density (ρ) and sound velocity (C) of the medium, measured in

$$Rayls = \frac{kg}{s} {m}^{2} .$$

For water, ρ_{w}≈1000 kg/m³ and C_{w}≈1500 m/s, so

Z_{w}=ρ_{w}C_{w}≈1.5 MRayls. Eq. 1

At atmospheric conditions for air, ρₐ=1.29 kg/m³ and Cₐ=333 m/s, so

Zₐ=ρₐCₐ≈430 Rayls. Eq. 2

The value of Zₐ depends on temperature and pressure, but the influence of these changes on the acoustic behavior of the system is negligible. Finally, for steel, which may be used for the buoyancy tank, ρₛ≈7800 kg/m³ and Cₛ≈6000 m/s, so

Zₛ=ρₛCₛ≈47 MRayls. Eq. 3

The reflection and transmission coefficient amplitudes at the interface between two media (1, 2) are given as

$${R}_{12} = \frac{{Z}_{2} - {Z}_{1}}{{Z}_{2} + {Z}_{1}} = 1 - {T}_{12} , {T}_{12} = \frac{2 {Z}_{2}}{{Z}_{2} + {Z}_{1}} . \qquad Eq . 4$$

The reflection coefficient of a steel-water interface is hence approximately 93.8%, while a steel-air interface is very close to 100%.

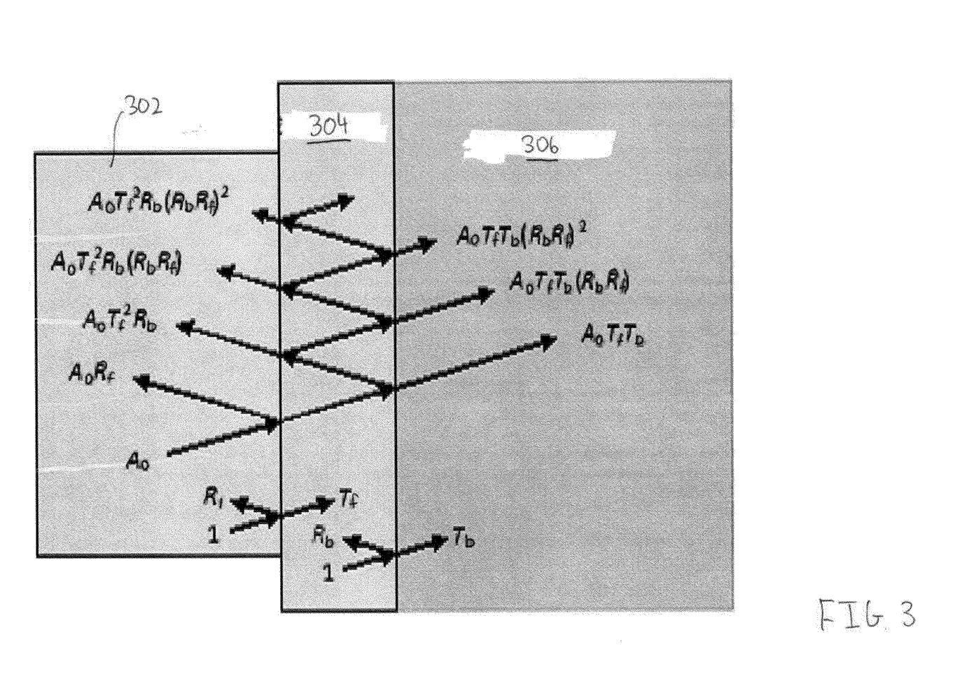

When a short acoustic pulse with initial amplitude A₀ is sent from a transducer 302 coupled to the wall 304 of a buoyancy tank containing contents 306 (e.g., air and/or water), the pulse undergoes multiple reflections within the steel wall 304, reducing amplitude upon each reflection. The reflected response acoustic pulses are detected when received and transmitted back into the transducer 302, and the amplitude of these pulses decreases by R_{b}R_{f} each time, as shown in FIG. 3.

### Measurement Approaches

The goal of the measurement system is to determine the value of R_{b}, either directly or indirectly, and interpret this value to determine whether air or water is present at the opposite face of the wall 304. There are numerous ways to achieve this goal, all of which have been demonstrated at the proof-of-concept level.

Short Pulse Measurement—

A short pulse measurement is achieved by sending a delta or voltage step from a high-frequency, highly-damped transducer, and measuring the resulting signal at high speed. In this way, the amplitude of each subsequent reflection is measured: A₀R_{f}, A₀T_{f}²R_{b} and A₀T_{f}²R_{b}(R_{b}R_{f}). This gives three equations and three unknowns (as T_{f}=1−R_{f}), allowing R_{b} to be calculated directly.

Single-Point, Single Transducer Ring-Down—

This approach uses a short, single-frequency burst as a drive signal to a transducer. Certain frequencies cause resonance within the wall, and after the drive signal is switched off, an acoustic signal will be emitted from the wall, gradually decaying as a characteristic ring-down signal. In this particular approach the power of the emitted acoustic signal is measured after a set time. If water is present on the opposite face, then this signal will be significantly lower than if air is present. This approach is thus an indirect measurement of R_{b}.

Dual-Point, Single Transducer Ring-Down—

This approach is similar to the single-point, single transducer ring-down approach, except that the signal is measured at two times. The ratio of these two signals thus gives an estimate of the speed of the decay, independent of the absolute transducer response. The decay is faster when water is present, compared to air.

Single-Point, Dual Transducer Ring-Down—

This approach is similar to the single-point, single-transducer ring-down approach, except that the signal is sent from one transducer and measured by an adjacent transducer. In this case, the measured signal is one that spreads out laterally within the wall as it undergoes multiple reflections. The transducers are positioned horizontally, ensuring that both transducers are equally covered by water. This approach simplifies the measurement electronics and ensures that the measured signal has undergone many reflections, which increases the contrast between the ‘air’ and ‘water’ signals.

Dual-Point, Dual Transducer Ring-Down—

This approach uses the dual-point approach to measure the decay rate independently of transducer response, and simplifies the measurement electronics by using separate transducers.

In one or more embodiments, the present disclosure may relate to a semi-permanent apparatus that may be coupled or fixed to a buoyancy tank as an in-situ status sensor and measurement of change in the gas/water level in each (or selected) section of the buoyancy tank. The apparatus may be a stand-alone compact sensor, such as referred to as a discrete compartment status sensor, that may be equipped with acoustic transducers or transducers coupled to the buoyancy tank using permanent magnets. At installation the apparatus can be placed by hand or by ROV on the exterior of the compartment or section of the buoyancy tank to be monitored, and left in place for periodic survey by a ROV through remote or wireless interrogation. The apparatus may determine the first change in internal condition (gas to water or water to gas) and/or the rate of water/gas ingression as the level passes the apparatus.

The apparatus may include an alarm that is triggered by certain conditions, readings, or actions, such as by receiving a specific signal from an acoustic transducer (e.g., if the water/gas ingression rate surpasses a predetermined limit). For instance, the alarm may include an optical output unit (e.g., a flashing light-emitting diode or a colored emission), an acoustic output unit, a wireless output unit, an inductive coupling unit, and a piezoelectric unit.

In one or more embodiments, an alarm shuttle may also be included with the apparatus, such as releasably coupled to the apparatus. The alarm shuttle may include a buoyant element (such as referred to as an alarm shuttle in this embodiment) and/or may include a floating element. The alarm shuttle may be liberated and raised to the surface for an alert in specific cases. For example, the alarm shuttle may include a transmission device, such as a radio-frequency device, and/or an identity tag to alert at the surface/sea level. A watching station may be used to look for the alarm shuttle and receive a transmission from the transmission device.

The use of at least two or more sensors, such as acoustic transducers, may allow detecting and determining of low flow rates of ingression with no limitation in the lowest range. The information can also be transmitted by the output device of the apparatus, such as by a flashing sequence, acoustics, or any remote protocol.

A series of monitoring apparatuses can be coupled to a buoyancy tank, with each apparatus coupled to a compartment. The apparatuses may then be inspected or surveyed during a scheduled inspection, maintenance, and repair, and/or as an ROV passes by during other surveying events.

Further, an apparatus may be used as a “life-of-field” monitoring device, such as manufactured for use during the life of the buoyancy tank, may be used as a simple periodic inspection tool, and/or may be used as a deployment aid to support ballasting or de-ballasting of compartments. Accordingly, the present disclosure may provide an improved sensor design combining water/gas level detection and rate of the level in a given period of time all gathered in a stand-alone package equipped with specific alarm devices. In the present disclosure, the apparatus may be able to operate for several years being supplied by an internal battery, requiring low power electronics and proper measurement management to control a given duty cycle of measurements. In one or more embodiments, the apparatus may include a standalone sensor packaged to be magnetically fixed on a buoyancy tank, or for other applications on the wall of any submarine metallic pipe or vessel.

The apparatus may be equipped with an optical output unit that can send flashes of various sequences to indicate if the water has been detected or not, if the lower sensor or transducer has seen water and not the upper, if two (or more) transducers have seen water, and/or what is the foreseen flow-rate ingression. An alarm shuttle can be included that may be released with positive buoyancy to reach the surface and send alerts to the surroundings (e.g., radio-frequency, light, signal, and the like).

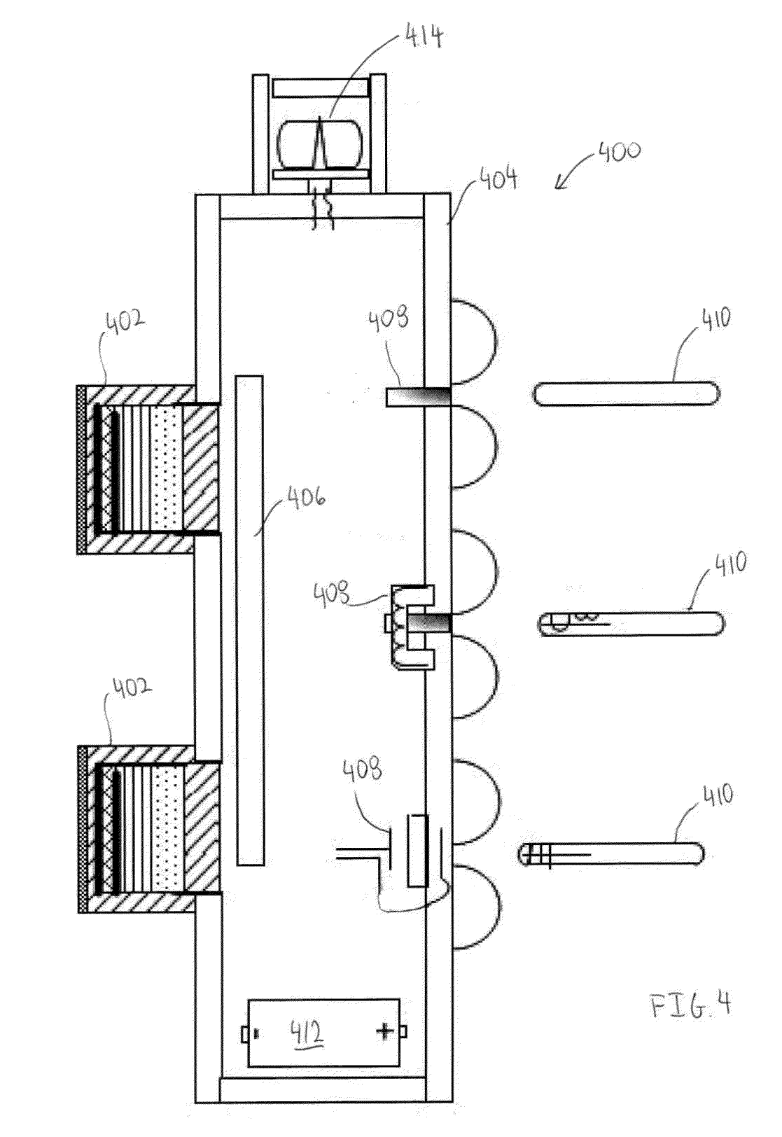

Referring now to FIG. 4, a schematic cross-sectional view of an apparatus 400 to acoustically monitor a container, such as a buoyancy tank, in accordance with one or more embodiments of the present disclosure. The apparatus 400 includes one or more sensors, and in particular acoustic transducers 402, to send acoustic signals into an interior of the container. In one or more embodiments, the acoustic transducers 402 may also receive acoustic signals from the interior of the container, such as the acoustic signals reflected back from being sent into the interior of the container.

The apparatus 400 may be coupled or mounted to the container, such as through the use of one or more magnets. For example, the acoustic transducers 402 may each include a magnet to couple the apparatus 400 to a container. The apparatus 400 may include a housing 404, such as that may include or be formed from a non-galvanic material to avoid corrosion. One or more components of the apparatus 400 may then be included within or coupled to the housing 404.

The apparatus 400 includes electronics 406 that are coupled to the acoustic transducers 402 to facilitate the operation and communication with the apparatus 400. The electronics 406 may include, for example, a circuit board with the acoustic transducers 402 directly coupled to the circuit board, and may include a data processing unit. The data processing unit (e.g., microprocessor) may be used to process the acoustic response signals received to determine the contents included within the interior of the container. For example, the data processing unit may use one or more of the methods, techniques, or approaches discussed above to determine the contents (e.g., gas or liquid, air or water) included within the interior of the container at the location of the acoustic transducers 402.

The data processing unit may also be used to manage communication with the apparatus 400, such as to communicate the contents determined within the interior of the container 400. For example, the apparatus 400 may include one or more output devices 408 to output the determinations from the data processing unit, such as the contents determined as included within the interior of the container. An output device 408 may include a wireless output device, an optical output device (e.g., a light signaling device), an acoustic output device, an inductive coupling unit, an electromagnetic unit, and/or a piezoelectric unit, in addition to other types of output devices.

As the output device 408 may be wireless, one or more wireless devices 410 may communicate with and receive the output from the output devices 408. For example, if the output device 408 is an optical output unit, the wireless device 410 may include an optical detector (e.g., a charge-couple device camera) to communicate with and/or receive signals from the optical output unit. If the output device 408 is an inductive coupling unit, the wireless device 410 may include an inductive coupler or coil to communicate with and/or receive signals from the inductive coupling unit. If the output device 408 is a piezoelectric unit, the wireless device 410 may include a piezoelectric coupler or reader to communicate with and/or receive signals from the piezoelectric unit. A piezoelectric unit and corresponding coupler may enable communication through the housing 404 without the need of a port, window, or other type of feed through, and a metallic housing 404 may also not interfere with such a communication. One or more of the output devices 408 and wireless devices 410 may include a centralizer (e.g., half-toroid element) as well, such as to improve communication therebetween. To facilitate communication with the output device 408, the output device 408 may be positioned on an opposite side of the housing 404 with respect to the acoustic transducers 402. Further, the apparatus 400 may include an internal power source 412, such as a battery positioned within the housing 404, to supply all of the power necessary for the apparatus 400.

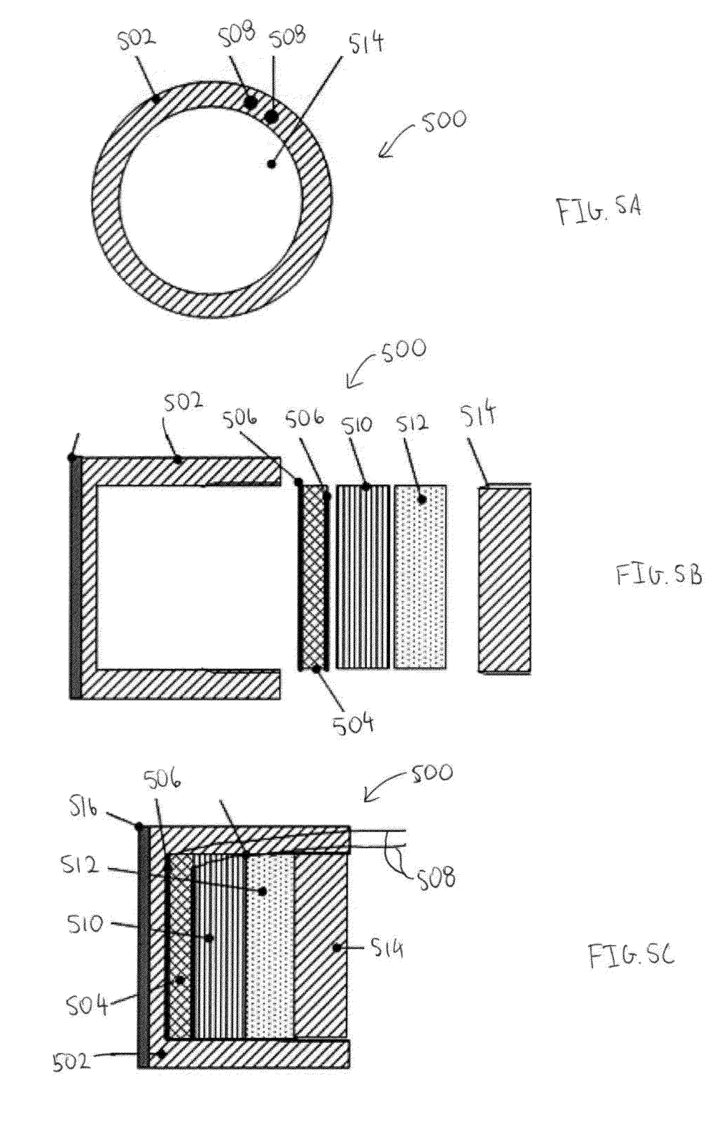

Referring now to FIGS. 5A-5C, multiple schematic views of an acoustic transducer 500 in accordance with the present disclosure are shown. The acoustic transducer 500 may include a sensor housing 502, such as to contain the components of the acoustic transducer 500. As the sensor is shown as an acoustic transducer 500 in this embodiment, the acoustic transducer 500 may include a piezoelectric cell 504. Electrodes 506 may be included on or connected to the piezoelectric cell 504 with electrical leads 508 connected to and extending from the electrodes 506. A backing material 510 and a magnet 512 may be included in the acoustic transducer 500, such as positioned within the housing 502. A fastener 514 may then be included to contain the piezoelectric cell 504, the backing material 510, and the magnet 512, such as by having the fastener 514 press-fit into engagement with the housing 502. Furthermore, as shown in FIGS. 5A-5C, an adaptation layer 516 may be included with the sensor, such as on an exterior of the housing 502. The adaptation layer 516 may allow better matching with respect to the impedance of the sensor and an exterior of the container, and/or may decouple sensor resonance from resonance of the wall of the container.

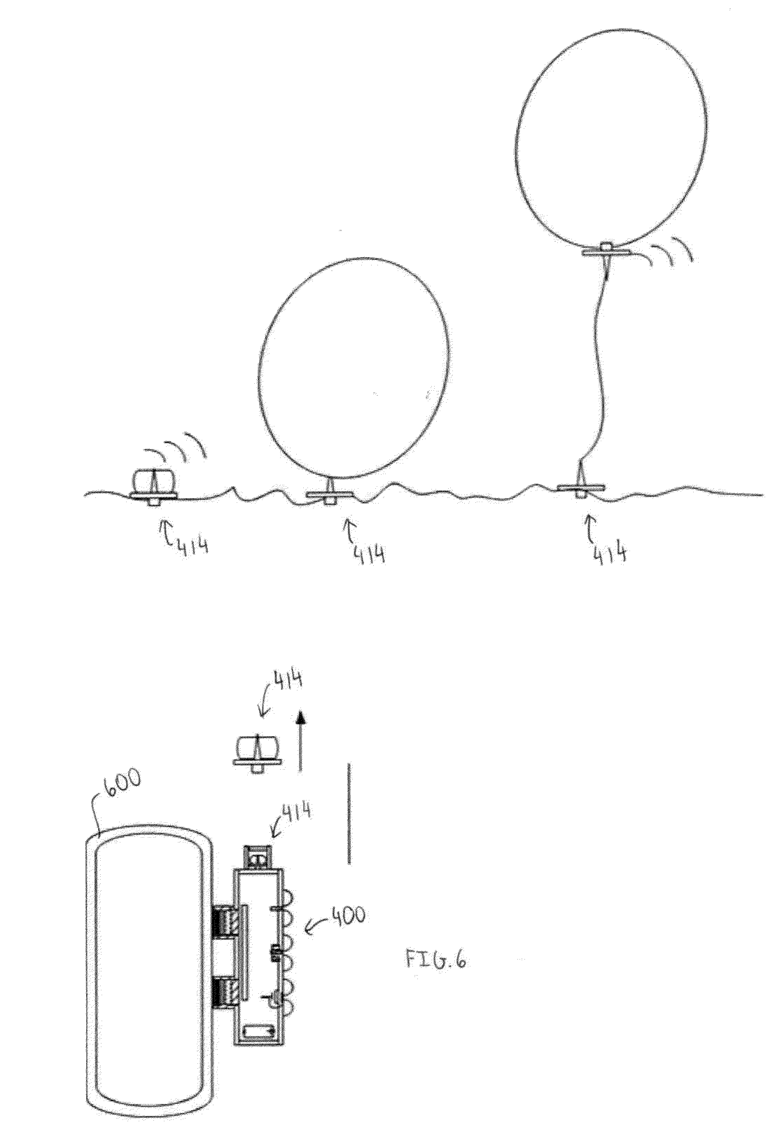

Referring now to FIGS. 4 and 6, the apparatus 400 may include an alarm shuttle 414 to communicate information related to the readings of the apparatus 400 and the status of a container 600 being monitored. The alarm shuttle 414 is releasably coupled to the apparatus 400, such as to the housing 404. The alarm shuttle may then be released from the apparatus 400 based upon predetermined conditions, such as if water is determined as present within the interior of the container 600, a rate of water ingress into the container 600 is above a predetermined rate, or no survey of the apparatus 400 is planned for a predetermined amount of time.

The alarm shuttle 414 may be buoyant or include a buoyant element to have the alarm shuttle 414, or a portion thereof, float to the sea surface. The alarm shuttle 414 may float or include a floating element to have the alarm shuttle 414, or a portion thereof, float above the sea surface. For example, as shown in FIG. 6, the alarm shuttle 414 may include a balloon to float to the surface or above the surface. The apparatus 400 or the alarm shuttle 414 may include a compressed gas canister, such as with helium, to inflate the buoyant or floating element of the alarm shuttle 414. The alarm shuttle 414 may then include a transmission device, such as a radio-frequency emission device, to transmit information related to the measurements and determinations of the apparatus. Surveillance stations in the vicinity may then be used to receive emissions from the alarm shuttle 414, such as to receive a signal containing information identifying the alarm shuttle 414, the apparatus 400, the container 600, and/or a particular compartment of the container 600. The alarm shuttle 414 may also include an identity tag, such as to facilitate identifying the location of the apparatus 400 of the container 600 related to the alarm shuttle 414.

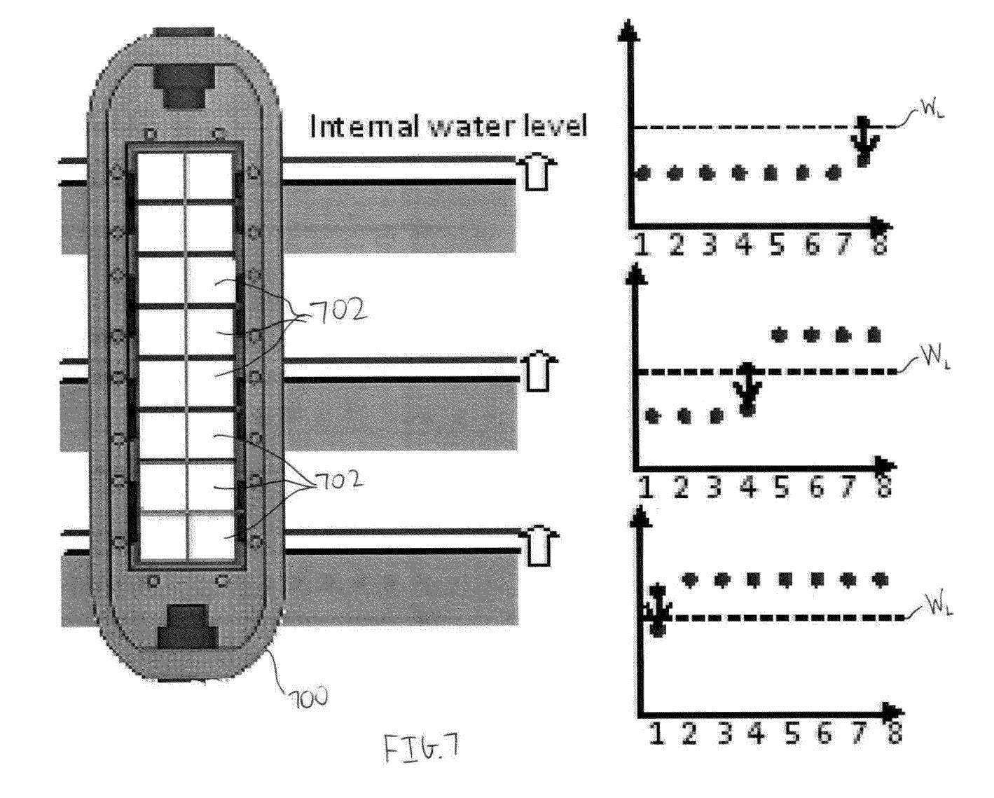

As mentioned above, a monitoring apparatus may include one sensor (e.g., acoustic transducer), two sensors, and/or more sensors. To facilitate measuring a level of liquid or water within a container, and more particularly a rate of ingression of liquid into, the monitoring apparatus may incorporate or use an array of sensors. An example of a monitoring apparatus 700 including an array of sensors 702 is shown in FIG. 7. The monitoring apparatus 700 includes eight sets of sensors 702 in this embodiment, with FIG. 7 showing a representation of the apparatus 700 used to monitor three different scenarios of an internal water level of a container. The response of the individual sensors below the water level are used to determine the lower “water” signal level, and the response of transducers above are used to determine the higher “air” signal level. A simple linear interpolation between these two extremes may give a precise water level W_{L} at the sensor that is partly submerged: for example, a signal halfway between the two levels indicates that the water level is halfway up the partly submerged transducer. A special case exists when the partly submerged transducer is at the top or bottom of the array. In this case, there will be one unknown level, which can be calculated from the ratio that may be determined during factory calibration.

In accordance with one or more embodiments, the present disclosure may provide a standalone apparatus that may be used to evaluate and determine, such as by acoustic measurement, a level of liquid or water included within a metallic housing or container, such as a buoyancy tank, steel jacket, floating hull, storage tank, and/or other similar containers or vessels. To facilitate measurement, the apparatus may be calibrated within a controlled environment, such as in a laboratory, before use and deployment in the field to ensure repeatability and reliability in the presence of air and/or water. The apparatus may include a local electronics board including a microprocessor to excite active transducers, listening to passive transducers, store data for flow-rate estimation, and/or may manage the data transfer to a ROV by various methods.

A primary communication method with the apparatus may include the use of a visual or optical output unit, though other output devices are discussed above. Distinguishable signals may be relayed from the output device to indicate normal operating conditions, and one or more other signals may be used to fault or alarm conditions that may be communicated, such as to an ROV that may be passing by the monitoring apparatus. The apparatus may also include a storage device, such as memory (e.g., flash memory) to store data recorded by the sensors of the apparatus.

To reduce the power consumption of the apparatus, the signal processing and duty cycle for the apparatus may be controlled to operate at predetermined times or intervals. For example, if no water is detected by the apparatus, then the apparatus and components thereof may go to sleep or on standby, and then only activated to take measurements at the next scheduled time or interval. This duty cycle can be adjusted for predetermined times or intervals, such as starting at T₀, the next at T₁. Once water is detected as present within the container by the apparatus, an alarm can be sent use one of the output devices. Further, the time or intervals scheduled for subsequent measurements can be reduced, such as to measure additional ingression of water into the container or the rate of ingression into the container.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. An apparatus to acoustically monitor a container, the apparatus comprising:
a first acoustic transducer mountable to an exterior of the container to send a first acoustic signal into an interior of the container;
a second acoustic transducer mountable to the exterior of the container to send a second acoustic signal into the interior of the container; and
a data processing unit to process a first acoustic response signal related to the first acoustic signal and a second acoustic response signal related to the second acoustic signal to determine contents within the interior of the container at locations of the first acoustic transducer and the second acoustic transducer.

2. The apparatus of claim 1, further comprising an output device to output the contents determined within the interior of the container determined by the data processing unit.

3. The apparatus of claim 2, wherein the output device comprises at least one of an optical output unit, an acoustic output unit, an inductive coupling unit, and a piezoelectric unit.

4. The apparatus of claim 2, further comprising a wireless device to communicate with and receive the output from the output device.

5. The apparatus of claim 2, further comprising a battery to power the apparatus.

6. The apparatus of claim 5, further comprising a housing with the first and second acoustic transducers positioned on a side of the housing, the output device positioned on an opposite side of the housing, and the battery positioned within the housing.

7. The apparatus of claim 1, further comprising an alarm shuttle releasably coupleable to the apparatus.

8. The apparatus of claim 7, wherein the alarm shuttle comprises at least one of a buoyant element and a floating element.

9. The apparatus of claim 8, further comprising a compressed gas canister to inflate the at least one of the buoyant element and the floating element.

10. The apparatus of claim 7, wherein the alarm shuttle comprises a transmission device to transmit information related to the contents included within the interior of the container determined by the data processing unit, and wherein the alarm shuttle comprises an identity tag.

11. The apparatus of claim 1, further comprising a magnet to couple the first transducer to the container.

12. The apparatus of claim 13, wherein at least one of the first and second acoustic transducers comprises a sensor housing with a piezoelectric cell, a backing material, and the magnet positioned within the sensor housing and an adaptation layer coupled to an exterior of the sensor housing.

13. The apparatus of claim 1, further comprising:
a third acoustic transducer mountable to the container to send a third acoustic signal into the interior of the container;
the data processing unit to process a third acoustic response signal related to the third acoustic signal to determine contents included within the interior of the container at a location of the third acoustic transducer.

14. A method to acoustically monitor a container, the method comprising:
sending a first acoustic signal into an interior of the container with a first acoustic transducer;
sending a second acoustic signal into the interior of the container with a second acoustic transducer; and
receiving a first acoustic response signal related to the first acoustic signal;
receiving a second acoustic response signal related to the second acoustic signal; and
determining the contents within the interior of the container at the locations of the first acoustic transducer and the second acoustic transducer based upon the first acoustic response signal and the second acoustic response signal.

15. The method of claim 14, further comprising:
outputting the determined contents within the interior of the container with an output device;
wherein the output device comprises at least one of an optical output unit, an acoustic output unit, an inductive coupling unit, and a piezoelectric unit.

16. The method of claim 15, further comprising:
receiving the determined contents from the output device with a ROV in communication with the output device.

17. The method of claim 15, further comprising:
receiving the determined contents from the output device with a wireless device in communication with the output device.

18. The method of claim 14, further comprising:
releasing an alarm shuttle from the apparatus based upon the determined contents included within the interior of the container.

19. The method of claim 14, further comprising:
determining a rate of ingression of fluid into the interior of the container based upon the first acoustic response signal and the second acoustic response signal.

20. The method of claim 14, further comprising:
decreasing time to send additional acoustic signals into the interior of the container if fluid is determined to be within the interior of the container.
